(19) United States
(12) Patent Application Publication
(10) Pub. No.: US 2009/0170051 A1
(43) Pub. Date: Jul. 2, 2009

(54) Lower jaw dental impression tray withy faux-tongue extension

(76) Inventors: Minerva Chi, (US); Charlemagne Chi, (US); Manuel Gochuico, Union City, CA (US)

Correspondence Address: MANUEL GOCHUICO, P.O. BOX 1006, UNION CITY, CA, 94587, US

(21) Appl. No.: 12/006,030

(22) Filed: Dec. 31, 2007

(51) Int. Cl. A61C 9/00

(52) U.S. Cl. 433/39

(57) ABSTRACT

A lower jaw dental impression tray with custom track and having a faux-tongue extension part in which the first part can be used for making a lower impression and wherein the second part extension is used to create a detailed, presentable diagnostic cast model, can be removed and combined from the tray itself.

The main purpose of the extension tongue is to come up with a detailed, presentable diagnostic cast model. (fastest way of doing a refined model, staying away from the hassle of mixing an alginate (irreversible hydrocolloid materials) and minimizing time and materials in making a diagnostic model.

The dental impression tray has a track the runs along the base of the flanges of the EZ-tray allowing the faux-tongue extension (trademarked and hereafter referred to as “EZ-tongue”) to slide into the EZ-tray.

### DRAWINGS

FIG. 1—Dental impression tray with custom faux-tongue track as viewed from the right. The track can be seen on the left of the drawing.

FIG. 2—Dental impression tray with custom faux-tongue track as viewed from the left the track can be seen on the right of the drawing.

FIG. 3—Dental impression tray with custom faux-tongue track as viewed from behind the track is shaded.

FIG. 4—Dental impression tray with custom faux-tongue track as viewed from the front.

FIG. 5—Faux-tongue extension groove as viewed from the top and viewed from the bottom.

FIG. 6—Faux-tongue extension as viewed from the left and viewed from the right.

FIG. 7—Faux-tongue extension as viewed from the front and viewed from behind.

FIG. 8—Dental impression tray with the faux-tongue extension attached as viewed from the top.

FIG. 9—Dental impression tray with the faux-tongue extension attached as viewed from the bottom.

FIG. 10—Dental impression tray with the track (shaded) and the faux-tongue positioned for insertion as seen from the top.

FIG. 11—Dental impression tray with the track (shaded) and the faux-tongue positioned for insertion as seen from the bottom.

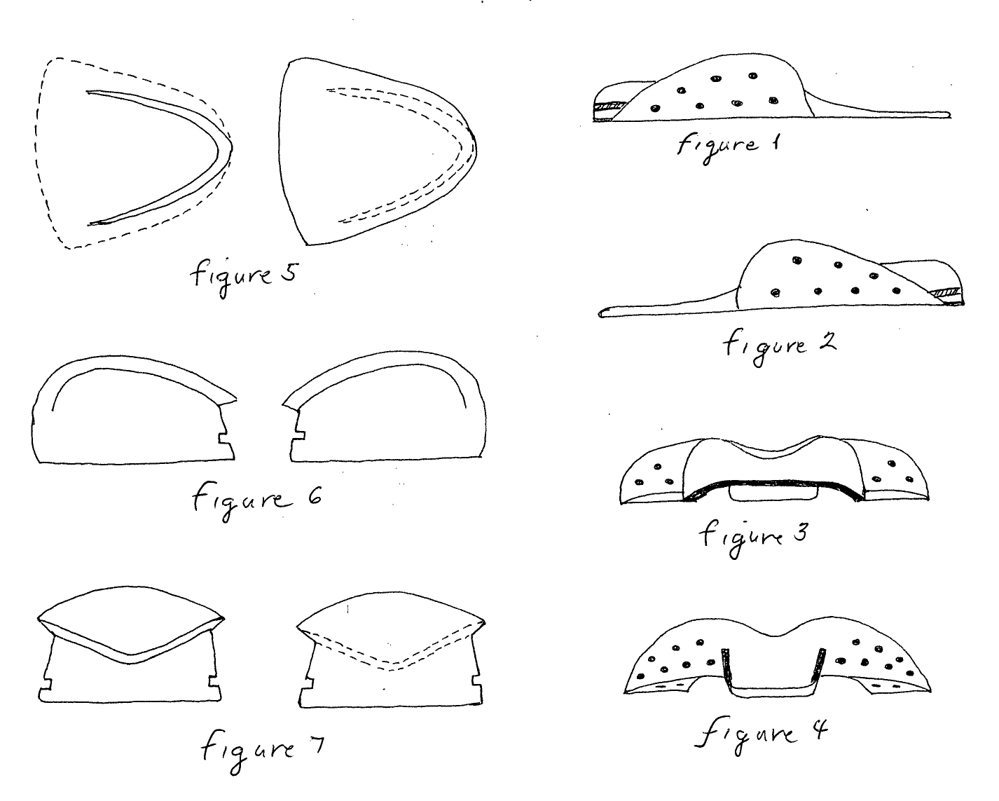

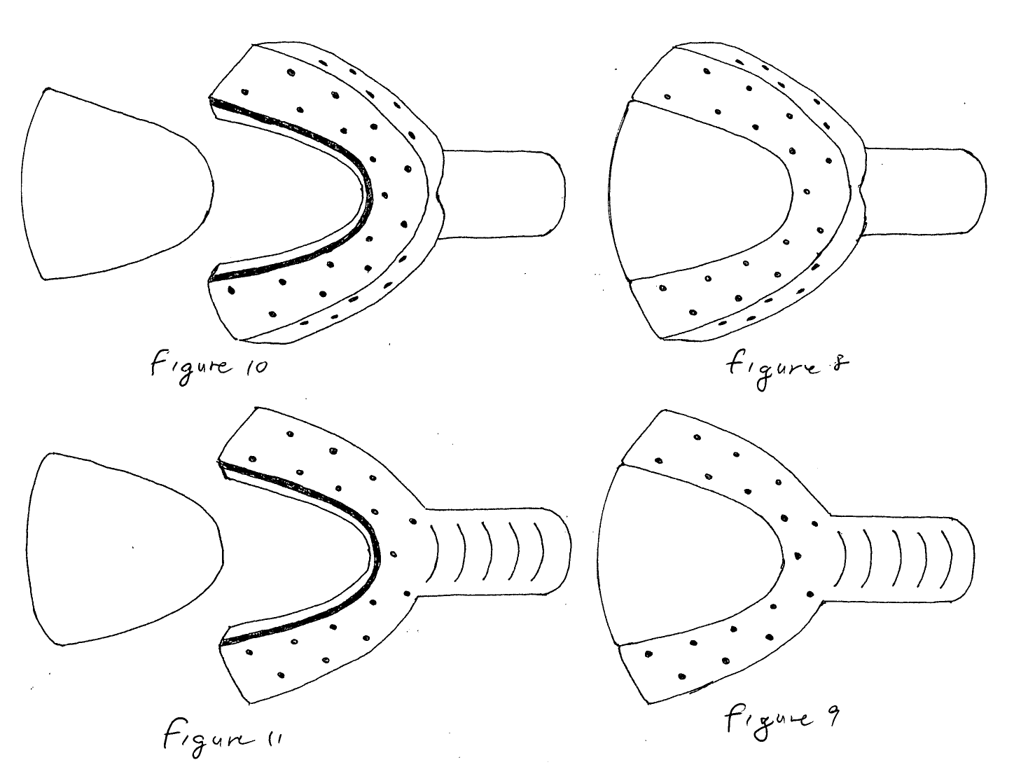

1. A lower jaw dental impression tray with custom track and having a faux-tongue extension part in which the first part can be used for making a lower impression and wherein the second part extension is used to create a detailed, presentable diagnostic cast model, can be removed and combined from the tray itself.
The main purpose of the extension tongue is to come up with a detailed, presentable diagnostic cast model. (fastest way of doing a refined model, staying away from the hassle of mixing an alginate (irreversible hydrocolloid materials) and minimizing time and materials in making a diagnostic model
